(19) United States
(12) Patent Application Publication
(10) Pub. No.: US 2024/0233053 A9
(43) Pub. Date: Jul. 11, 2024

(54) COMMERCIAL REAL ESTATE FINANCING STRUCTURE AND RELATED METHODS

(71) Applicant: David Delach, Deer Park, IL (US)

(72) Inventor: David Delach, Deer Park, IL (US)

(21) Appl. No.: 18/381,730

(22) Filed: Oct. 19, 2023

Related U.S. Application Data
(60) Provisional application No. 63/417,562, filed on Oct. 19, 2022.

(51) Int. Cl. G06Q 50/16; G06Q 40/06

(52) U.S. Cl. CPC G06Q 50/165; G06Q 40/06

(57) ABSTRACT

A tenant backed securities financing structure is disclosed for a commercial real estate development project. In this financing structure, a developer and an investment partner form a real estate development entity. The investment partner provides the funding for the real estate development project to build an asset and the developer builds the asset. The tenant secures the real estate development entity with a lease for the asset which mitigates the risk of the real estate development entity in the project. The lease provides the tenant with an option for the tenant to acquire the lease below the market value of the real estate asset.

### FIELD

This disclosure relates to a financing structures and methods for financing commercial real estate development projects.

### BACKGROUND

In a conventional build to suit commercial real estate development, both the developer and tenant are exposed to market risks that have a negative impact on their businesses. In a typical commercial build to suit project, a developer and tenant enter into a lease agreement to create a building to the tenant's specification. Conventional financing for a standard build to suit project requires the developer to contribute a combination of debt and equity. For example, a developer may provide 20%-30% of the funds for the project (equity) and borrow the remaining 70%-80% needed for the project (debt) from the lender. When the project is complete, the developer generally sells the lease to another buyer thus paying off the debt, returning the developer's equity, and generating a profit if successful. Developers incur significant risk as the development cycle (negotiate lease, generated building plans, secure permits, and build) is generally 18 to 24 months. During the development cycle, the capital market can change significantly which could result in an erosion of the developer's profit, loss of equity, and/or even default on the loan.

The tenant likewise faces business risks such as: 1) escalating real estate taxes; 2) owner performance issues; and 3) tenant remodel costs. Multiple lease sales can result in continuous real estate tax escalation which the tenants are generally required to pay as part of the lease agreement for commercial real estate. Once the tenant's lease is sold to a 3^{rd} party investor, there is no assurance that the 3^{rd} party investor has the ability to perform as a landlord and provide the services required under the lease. It is not uncommon for the 3^{rd} party investor to be a high net worth individual without a commercial real estate staff to perform basic landlord services (landscaping, snow plowing, roof repairs, etc.). In many cases, the tenant spends significant time and resources to ensure the new owner (e.g., the 3^{rd} party investment group) performs these basic services of the lease agreement. In addition to lease performance issues, the tenant generally needs to remodel the space every five years to keep the interior up to corporate standards and meet local demand. As one example, prior to the COVID pandemic most Quick Serve Restaurants (“QSR's”) served guests in both the café and drive thrus. After the onset of the COVID pandemic, retailers started online ordering for food and beverages. To accommodate these changes, retailers updated the interior of the retail space to address customers ordering online, picking up at the store, and consuming off site. Tenants often have to budget for these remodel costs and pay for the remodel work to be performed.

### BRIEF DESCRIPTION OF THE DRAWINGS

FIG. 1 is a diagram showing a tenant backed securities financing structure for a real estate development project.

FIG. 2 is a diagram showing steps of the tenant backed securities financing structure of FIG. 1 over time.

### DETAILED DESCRIPTION

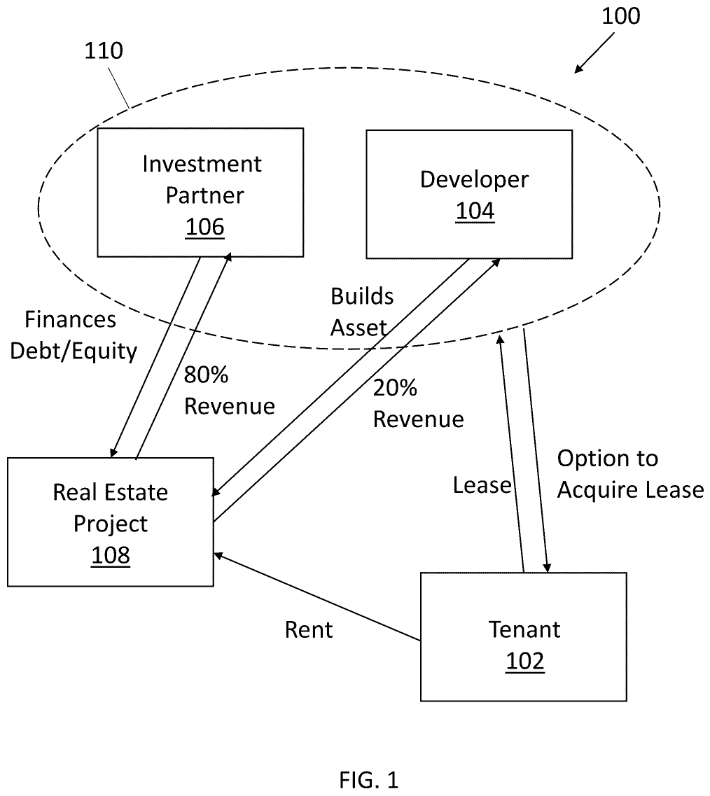

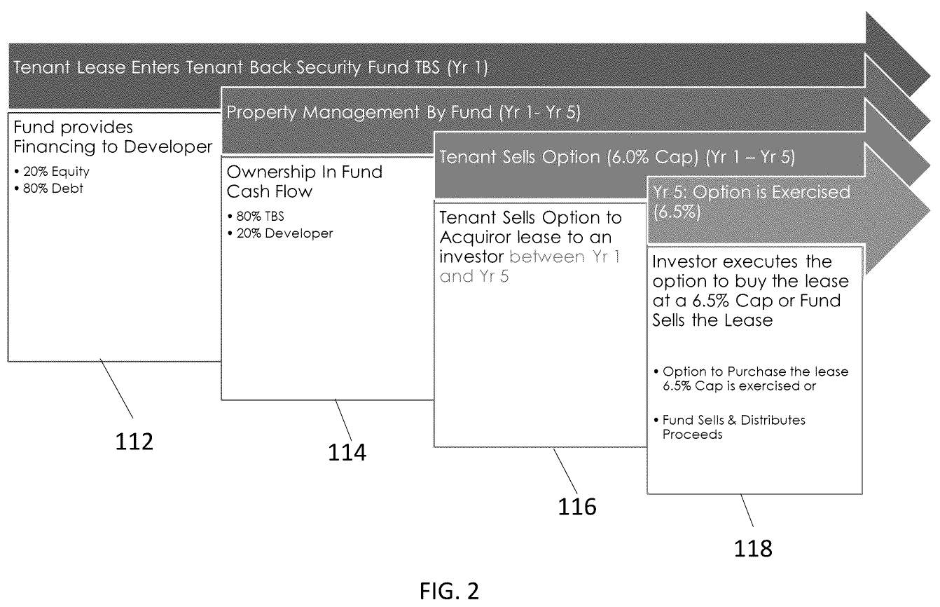

With reference to FIGS. 1-2, a tenant backed securities financing structure 100 is disclosed for a commercial real estate development that addresses the above-mentioned problems and benefits each of a tenant 102, a developer 104, and an investment partner 106. The financing structure may be used for a build to suit commercial real estate development project 108 for the tenant. The financing structure is preferably used for expanding credit worthy tenants. In this financing structure 100, the developer 104 and investment partner 106 may form a real estate development entity, such as a joint venture 110. In other forms, the developer 104 and the investment partner 106 form an entity of which both are members/shareholders. The investment partner 106 (e.g., a fund) may provide 112 all of the funding for the project to build an asset such that the developer 104 does not finance the project as in conventional commercial real estate financing structures. The tenant 102 secures the joint venture between the investment partner 106/developer 104 with a lease in exchange for some upside in the asset sale. This financing structure 100 takes advantage of expanding good credit of the tenant 102 and thus the tenant 102 preferably has a high credit rating (e.g., AAA). The tenant 102 is preferably an established business with a large-scale growth plan. For example, the tenant 102 may be a nationwide chain of businesses such as, for example, pharmacies, coffee shops, restaurants (e.g., QSRs), soft goods retailers, hard goods retailers, etc.

In the tenant backed securities financing structure 100, the developer 104 approaches an investment partner 106 to fund 112 both debt and equity for the project 108 instead of the developer providing 20-30% of their own equity and acquiring 70% to 80% of debt from a lender. The developer 104 and the investment partner 106 form a joint venture 110. In the joint venture 110, the developer 104 may complete the entitlement process and build the asset while the investment partner 106 provides the financing (debt and equity) for the project 108. The tenant 102 securitizes the joint venture 110 with a lease agreement which mitigates or eliminates the development risk inherent in commercial real estate projects. Upon completion of building the asset, the tenant 102 leases the development and may move in and occupy the asset. The joint venture 110 receives the cash flow of the rent payments from the tenant 102. The joint venture 110 may further receive the sale price of the development when the asset built in the real estate project 108 is sold (reversion). The developer 104 and the investment partner 106 may agree to divide 114 the income generated from the project 108. For example, the investment partner 106 may be entitled to receive 80% of the cash flow of the project 108 and the developer 104 entitled to receive 20% of the cash flow of the project 108.

The tenant 102 signs a lease for the property 108 for a base term, for example, five to twenty years. In the initial lease agreement, the tenant 102 receives a right to acquire the lease from the investment partner 106 and developer 104 during the base term (e.g., 5 years) at a set price established by a capitalization rate (“cap rate”). Cap rate is a term in commercial real estate that refers to the way a building is evaluated. Cap rate is calculated by dividing the net operating income by the cost of the building in order to give the rate of return. The lower the cap rate the higher the asset value and the higher the cap rate the lower the asset value. The tenant 102 may exercise 116 their option to acquire their lease anytime during the base term (e.g., after year five) at a cap rate above the market cap rate for their lease. The ability of the tenant 102 to acquire their own lease for a price below fair market value (via the higher cap rate) creates value in the option which can be sold to another investment partner 106 who wishes to buy the asset.

As one specific example, the annual rent of the asset is $137,200 and the tenant 102 receives the option to acquire the lease at a 6.5% cap rate during a five-year base term of the lease. Assuming the tenant's lease typically sells at a 6.0% cap rate, the tenant 102 is able to sell 116 their option to acquire the lease to a third-party investor which could generate approximately $176,000 of leasehold income—the difference between the market value at a 6.0% cap rate ($2,286,700) and the tenant's option to acquire the lease at 6.5% below market cap rate ($2,110,800). The third-party investor who acquires the tenant's option for $176,000 is able to buy 118 the lease below market (e.g., $2.11 million vs $2.28 million). This money the tenant 102 earns from the leasehold interest by selling their option may be utilized by the tenant 102, for example, to remodel the property. This structure allows the tenant 102 to participate in the revenue generated from the credit inherent in their own lease. In conventional financing structures, the leasehold value is generally retained by the developer as compensation for the development risk. In the tenant backed securities structure 100 of this disclosure, however, the developer's 104 risk is mitigated or eliminated by the investment partner 106 financing the development and the leasehold interest is instead retained by the tenant 102. The option value in this example is the tenant's 102 leasehold interest.

In some forms, the tenant 102 is a part owner of the development, for example, a 3%-15% owner. The tenant 102 may then also receive 3%-15% of the cash flow (e.g., rental income and sale of the lease) of the property according to their ownership share of the development.

Thus, the tenant backed securities financing structure 100 benefits the investment partner 106, the developer 104, and the tenant 102. The joint venture 110 (e.g., the developer 104 and investment partner 106) trades off a reduction in risk for a lower asset sale price (e.g., compared to market value). The lower sale price given to the tenant 102 by way of the option to acquire the lease allows the tenant 102 to profit by selling their below market option to the investment community. Thus, the tenant 102 is thus able to participate in the revenue upside created by their good credit. The joint venture 110 receives revenue from both the rent paid by the tenant 102 and payment from a subsequent purchaser of the lease when they exercise the option purchased from the tenant 102. The investment partner 106, developer 104, and/or tenant 102 may divide the revenue received from rent and the sale of the lease, for example, based on their ownership share of the development. The revenue split between the investment partner 106, developer 104, and/or tenant 102 may be specific to each project and may vary for each project, for example, based on risk of the project, local market conditions, etc. The tenant back securities financial structure 100 is scalable and thus it is expected that the investment partner 106 would fund multiple projects with the developer 104 and/or tenant 102 in the same fund and thus the size of the fund could begin with as few as one lease and may grow to hundreds of leases.

Uses of singular terms such as “a,” “an,” are intended to cover both the singular and the plural, unless otherwise indicated herein or clearly contradicted by context. The terms “comprising,” “having,” “including,” and “containing” are to be construed as open-ended terms. It is intended that the phrase “at least one of” as used herein be interpreted in the disjunctive sense. For example, the phrase “at least one of A and B” is intended to encompass A, B, or both A and B.

While there have been illustrated and described particular embodiments of the present invention, those skilled in the art will recognize that a wide variety of modifications, alterations, and combinations can be made with respect to the above-described embodiments without departing from the scope of the invention, and that such modifications, alterations, and combinations are to be viewed as being within the ambit of the inventive concept.

What is claimed is:

1. A method for financing a real estate development by an investment fund, the method comprising:
forming a real estate development entity with a real estate developer to build a real estate asset;
providing funding for building the real estate asset; and
leasing the real estate asset to a tenant in a lease with an option for the tenant to acquire the lease below a market value of the real estate asset.

2. The method of claim 1 further comprising receiving from the tenant a rent payment for leasing the real estate asset and dividing a revenue of the real estate asset with the real estate developer.

3. The method of claim 2 wherein dividing the revenue includes dividing the revenue such that the investment fund receives about 70%-80% of the revenue and the real estate developer receives about 20%-30% of the revenue.

4. The method of claim 1 wherein providing funding includes providing all of the funding for building the real estate asset.

5. A method for financing a real estate development by a developer, the method comprising:
forming a real estate development entity with an investment partner to build a real estate asset, the investment partner to provide funds for building the real estate asset;
leasing the real estate asset to a tenant with an option to acquire the lease below a market value of the real estate asset; and
building the real estate asset using the funds of the investment partner.

6. The method of claim 5 further comprising receiving from the tenant a rent payment for leasing the real estate asset and dividing a revenue of the real estate asset with the investment partner.

7. The method of claim 6 wherein dividing the revenue includes dividing the revenue such that the investment partner receives about 70%-80% of the revenue and the developer receives about 20%-30% of the revenue.

8. The method of claim 5 wherein the investment partner provides all of the funds for building the real estate asset.

9. A method for generating revenue from credit of a tenant, the method comprising:
leasing a real estate asset from a real estate development entity in a lease with an option to acquire the lease from the real estate development entity below a market value of the real estate asset; and
selling the option to acquire the lease to an investor.

10. The method of claim 9 wherein the tenant is a part of the real estate development entity, the method further comprising:
receiving a portion of the revenue of the real estate asset from the real estate development entity.

11. The method of claim 10 wherein the revenue of the real estate asset is generated from rent payments of the tenant for the real estate asset and/or a sale of the real estate asset.
